(19) United States
(12) Patent Application Publication
(10) Pub. No.: US 2006/0231540 A1
(43) Pub. Date: Oct. 19, 2006

(54) Method and apparatus for short-circuit welding

(75) Inventor: Elliott K. Stava, Sagamore Hills, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Lincoln Global, Inc.

(21) Appl. No.: 11/109,565

(22) Filed: Apr. 19, 2005

(51) Int. Cl. B23K 9/09

(52) U.S. Cl. 219/137 PS; 219/137 WM; 219/130.51

(57) ABSTRACT

Methods and systems are disclosed for modified short-circuit welding of dissimilar metal workpieces, such as stainless steel and low-carbon steel pipe sections, in which a welding electrode is energized to provide a series of modified short-circuit welding cycles with advanced control over applied energy to facilitate joining two different metals to create a pipeline that is resistant to corrosion.

### INCORPORATION BY REFERENCE

Short-circuit arc welding systems, techniques, and associated concepts, as well as pipe welding methods and apparatus are generally set forth in the following United States patents, the contents of which are hereby incorporated by reference as background information: Parks U.S. Pat. No. 4,717,807; Parks U.S. Pat. No. 4,954,691; Parker U.S. Pat. No. 5,676,857; Stava U.S. Pat. No. 5,742,029; Stava U.S. Pat. No. 5,961,863; Parker U.S. Pat. No. 5,981,906; Nicholson U.S. Pat. No. 6,093,906; Stava U.S. Pat. No. 6,160,241; Stava U.S. Pat. No. 6,172,333; Nicholson U.S. Pat. No. 6,204,478; Stava U.S. Pat. No. 6,215,100; Houston U.S. Pat. No. 6,472,634; and Stava U.S. Pat. No. 6,501,049.

### FIELD OF THE INVENTION

The present invention relates to welding equipment in general, and more particularly to apparatus and methods for shirt-circuit welding.

### BACKGROUND

Pipe welding involves joining the longitudinal ends of generally cylindrical pipe sections to form an elongated pipeline structure with an interior suitable for transporting fluids, whether gaseous or liquid. The ends of the pipe section are typically machined to provide an outwardly facing external bevel and a narrow flat land. The ends of two adjacent sections are then situated proximate one another in axial alignment using some form of clamping arrangement with the ends proximate one another, typically in a closely spaced relationship to provide a narrow gap between the two lands with the beveled surfaces forming a weld groove. The pipe ends are then welded to one another using an initial root pass to form a root bead to fill the gap between the land edges, followed by several filler passes in which the groove formed by the beveled edges is filled so that the weld metal is at least flush with the outer surface of the pipe. Forming the root bead in the narrow gap is often difficult because the welding position varies from down-hand welding, vertical up or down welding, to overhead welding as the root pass proceeds around the circumference of the pipe. Several different pipe welding techniques have been used in the past, each having certain advantages and disadvantages. Gas tungsten arc welding (GTAW, also referred to as tungsten inert gas (TIG) welding) provides relatively low travel speeds with high heat input, and requires high operator skill level. Gas metal arc welding (GMAW, also known as metal inert gas (MIG) welding) allows higher lineal welding travel speeds than GTAW pipe welding. However, heat input is difficult to control and fusion may not always be 100 percent using this type of welding process. Shielded metal arc welding (SMAW) is cost effective in terms of equipment but requires high operator skill and suffers from frequent starts and stops in the welding process. Short-circuit type welding has also been successfully applied to pipe welding situations, wherein high frequency switching type welding supplies are used to weld the pipe sections using waveform controls with external shielding gas.

To ensure that the pipe section joints will not leak, particularly for steam or pressurized fluid transfer applications, a weld must penetrate completely through the pipe. Accordingly, pipe welding codes for field and in-plant applications require high-quality root pass welding. The initial root pass weld is also important because once completed, the alignment of the pipe sections is fixed, and welding of the next joint down the line can be commenced. The root bead ideally fills the narrow gap between the lands to provide a smooth interior welded surface without protrusions so as to provide an essentially unobstructed flow path for transferred fluids without undue fluid mixing and/or turbulence, and to allow passage of cylindrical cleaning devices and/or product separation devices (e.g., pigs) through the interior of the pipeline without interference. The root bead may be created from the interior of the pipe to ensure minimal protrusion of the root bead in the pipe interior; however, this approach may require specially designed and costly equipment, is very time-consuming, and is applicable only for pipes having diameters large enough to accommodate welding equipment inside the pipe. Another approach involves the use of backplates or back-up shoes positioned on the interior of the pipe to cover the gap between the pipe sections to thereby prevent the root bead from protruding into the pipeline interior. The use of backplates, however, is also very time-consuming and is again limited to relatively large diameter pipes. Furthermore, the backplate may become welded to the interior of the pipe section, requiring an extra removal step that may result in damage to the root bead. Yet another technique involves using a welding apparatus having two welding bugs which continuously move on a track around the periphery of the pipe to form the root bead, as shown in Parker U.S. Pat. No. 5,676,857.

It is also important to ensure that the metallurgy of the root bead and filler welds match that of the pipe sections being joined, and also that the weld joint is structurally sound. Ideally, the composition of the weld metal should closely match the composition of the metal pipe to form a strong and durable weld bead, particularly for high alloy steel pipe sections. In this regard, the alloy composition of the weld metal of the root bead is largely dependent upon the composition of the welding electrode used in the pipe welding process, and on any exposure of the weld process to atmospheric impurities. For instance, short-circuit pipe welding typically employs a solid welding electrode with material composition matching that of the pipe sections, together with an externally supplied shielding gas to protect the weld joint from oxidation, nitridation, and/or other adverse ambient effects, wherein the composition of the root weld bead is limited to the available alloy compositions of electrodes for use in short-circuit welding. The shielding gas prevents or inhibits oxygen, nitrogen, hydrogen, and/or other atmospheric compounds from reacting with the molten metal and/or from being trapped in the molten metal. These elements, if allowed to reach the molten weld metal, can cause porosity in the solidified weld bead, cracking of the welding bead, spattering of the weld metal, etc., which can significantly compromise the strength and quality of the resulting weld joint. The use of external shielding gas in a controlled indoor environment is effective in preventing the adverse effects on the weld bead from the environment; however, this technique is highly susceptible outdoors due to the effects of wind during the welding process. Special shields may be constructed around the perimeter of the electrode to protect the shielding gas from the wind during welding, but this adds to the cost and complexity of the system and process. Moreover, external shielding gas processes require provisions for storing and directing shielding gas to the area of welding.

Another challenge in pipe welding is preventing or inhibiting corrosion of the pipe and the weld joints. In operation, the pipeline may be used to transfer gas or liquids having corrosive properties that may change with the temperature of the fluid in transport. In particular, pipeline sections made from low carbon steel or other relatively low cost metal materials may tend to corrode when certain fluids are pumped therethrough, particularly at high fluid temperatures. In this regard, the temperature of the transported fluid may vary significantly along the length of a pipeline, wherein pipeline sections and weld joints thereof in which the fluid is very hot may corrode at a higher rate than those within which the fluid is at lower temperatures. Higher quality materials such as stainless steel may of course be used to construct pipelines through which highly corrosive fluids are to be transferred. However, such corrosion resistant materials are expensive, and the difference in cost may prohibit the construction of lengthy pipelines exclusively using pipe sections made from such materials. To address the tradeoff between corrosivity and cost, sections of a pipeline which will experience high fluid temperatures may be constructed with higher quality material, while cooler portions of the pipeline may be formed using lower cost pipe sections. However, variation in the composition of the pipe sections can lead to problems in forming structurally sound weld joints that are not prone to corrosion between sections of dissimilar metals. Accordingly, there remains a need for improved methods and systems for welding pipe sections to create pipelines capable of withstanding high transported fluid temperatures without significant corrosion.

### SUMMARY

A summary of one or more aspects of the invention is now presented in order to facilitate a basic understanding thereof. This summary is not an extensive overview of the invention, and is intended neither to identify specific elements of the invention, nor to delineate the scope of the invention. The primary purpose of the summary is, rather, to present some concepts of the invention in a simplified form prior to the more detailed description that is presented hereinafter. The present invention relates to short-circuit welding methods and systems for joining dissimilar metals, such as adjacent pipe sections made from different types or alloys of steel, by which pipelines can be constructed using pipe sections selected to minimize corrosion while ensuring structural integrity and suitable weld joint composition without unduly increasing pipeline construction costs. Modified short-circuit welding techniques are used in joining workpieces of different metallurgical constitution, in which a welding electrode is energized to provide a series of modified short-circuit welding cycles with advanced control over applied energy to facilitate joining two different metals to create a pipeline that is resistant to corrosion. The invention thus finds particular utility in the construction of pipelines wherein adjacent pipe sections are constructed of differing materials to economically mitigate pipeline corrosion, in which relatively high welding speeds are possible with control of heat input, spatter, and fume generation (smoke). The controlled low heat input of the invention can offer superior mechanical and metallurgical properties in the weld bead as well as the surrounding heat affected zones of the dissimilar pipe section workpieces. As a result, the pipe line section materials can be selected according to corrosivity and cost considerations without sacrificing pipeline integrity.

In accordance with one or more aspects of the invention, methods are provided for welding, which can be used in pipe welding situations to join longitudinal ends of pipe sections or in other applications in which two workpieces made of different materials are to be welded. In the context of pipe welding, the methods of the invention can be advantageously employed in creating the initial root pass weld bead and/or in performing subsequent filler welds in joining the dissimilar pipe sections. The method includes locating edges of first and second workpieces proximate one another, such as touching or in a closely spaced relationship with a narrow gap therebetween, where the first and second workpieces are of different first and second metals. The dissimilar metals may be of any constitution, including but not limited to steel, nickel, copper, stainless steel, steel alloys, nickel alloys, copper alloys, stainless steel alloys, and/or combinations thereof. The method further comprises directing a welding electrode toward the workpiece edges and energizing the electrode to cause deposition of molten metal from the electrode to the workpieces in a sequence of welding cycles. The welding electrode can be solid or cored, and an alloying material thereof may be tailored according to the first and second metals so as to facilitate joining the workpieces. The welding cycles employed in the method include an arc condition, a short-circuit condition, and a fuse condition. In the arc condition, the electrode is spaced from the workpieces, with the electrode current creating an arc therebetween and causing molten metal to form generally in the shape of a ball at an end of the electrode. The molten metal then contacts the workpiece during the short-circuit condition, and is transferred from the electrode to the workpieces or a weld pool formed thereon until the molten metal eventually separates from the electrode in the metal breaking fuse condition of the weld cycle. The method further comprises controlling the electrode current according to a detected start of the short-circuit condition and according to a detected or anticipated start of the metal breaking fuse condition, with a controlled boost pulse being provided to the electrode during the arc condition to establish an arc length and to form the molten metal, along with provision of a controlled background current after the boost pulse to control heating of the arc until a short-circuit condition of a subsequent welding cycle.

Another aspect of the invention relates to a welding system, comprising a supply of welding electrode with an alloying material tailored to join first and second metals at the edges, and a wire feeder that directs the electrode toward the workpiece edges. The system further includes a switching power source and a waveform generator or controller. The power source provides the electrode current as a plurality of relatively fast pulses that together create a waveform according to the waveform generator, with the waveform being replicated in a series of welding cycles to deposit molten metal from the electrode to the workpieces. Each of the welding cycles includes and arc condition with a boost pulse and a subsequent background current, a short-circuit condition, and a fuse condition, wherein the current is controlled according to a detected start of the short-circuit condition and according to a detected or anticipated start of the metal-breaking fuse condition.

### BRIEF DESCRIPTION OF THE DRAWINGS

The following description and drawings set forth in detail certain illustrative implementations of the invention. These are indicative of only a few of the various ways in which the principles of the invention may be employed. Other objects, advantages and novel features of the invention will become apparent from the following detailed description of the invention when considered in conjunction with the drawings, in which:

FIG. 1 is a partial side elevation view showing portions of two pipe sections of dissimilar metals joined by welding in accordance with one or more aspects of the present invention;

FIG. 2 is a partial side elevation view in section taken along line 2-2 of FIG. 1 illustrating a modified short-circuit arc welding process to join first and second metals at the ends of the pipe sections in FIG. 1;

FIG. 2A is a top plan view in section taken along line 2A-2A in FIG. 2 illustrating a solid welding electrode that may be used in the welding methods and systems of the invention;

FIG. 2B is a top plan view in section taken along line 2B-2B in FIG. 2 illustrating a cored electrode that may be used in various implementations of the invention;

FIG. 3 is a graph illustrating corrosivity of a low carbon steel pipe section as a function of temperature for a given transported fluid, wherein corrosion is at acceptable levels for ambient temperature and increases to an acceptance limit as temperatures increase to a second higher temperature;

FIG. 4 is a partial side elevation view illustrating a pipeline formed by welding ends of a plurality of pipe sections with heated fluid being introduced at a first pipeline end formed of stainless steel pipe sections, and with low carbon steel sections being employed a certain distance from the first end;

FIG. 5 is a graph showing fluid temperature as a function of pipeline distance for the pipeline of FIG. 4, wherein the fluid temperature decreases as the distance from the first pipeline end increases, to a point after which low carbon steel pipe sections can be used with acceptable levels of corrosion;

FIG. 6 is simplified schematic diagram illustrating a modified short-circuit welding system for joining dissimilar metals, including a switching power source and a waveform generator in accordance with the invention;

FIGS. 7A and 7B are graphs illustrating arc current and voltage waveforms, respectively, in the form of a series of welding cycles for welding dissimilar metals in accordance with the invention; and

FIGS. 8A-8F are partial side elevation views in section showing deposition of molten metal from a welding electrode to the two dissimilar workpieces at various times in a modified short-circuit welding cycle of FIGS. 7A and 7B.

### DETAILED DESCRIPTION OF THE INVENTION

One or more implementations of the present invention will now be described with reference to the drawings, wherein like reference numerals are used to refer to like elements throughout and wherein the illustrated structures are not necessarily drawn to scale. The invention provides methods and systems for short-circuit welding dissimilar metals and is illustrated and described hereinafter in the context of a pipe welding application in which a low carbon pipe section is welded to a stainless steel section using a flux-cored electrode in a modified short-circuit welding system employing waveform control technology developed by the Lincoln Electric Company of Cleveland, Ohio. While the invention is not limited to the illustrated implementations and may be performed to weld any workpieces of different metal materials using any suitable welding equipment with or without external shielding gas, it will be appreciated that the invention provides significant advantages in the fabrication of pipelines for transporting petroleum products or other fluids (gases and/or liquids) for joining pipe sections of dissimilar metals, wherein open root bead weld passes and/or subsequent fill welds can be completed expeditiously using the waveform control aspects set forth herein with low heat input, controllable spatter and fume generation, and no lack of fusion, particularly compared with prior GTAW pipe welding techniques. By the inventive methods, moreover, consistent, X-ray quality welds can be created to attain the corrosion resistance required for in-plant or field pipeline installations.

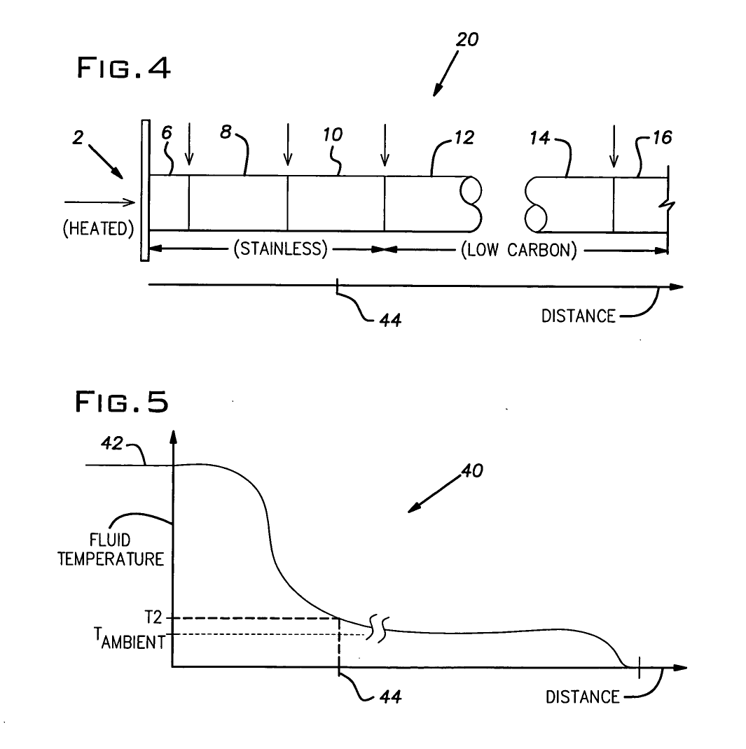

Referring initially to FIGS. 3-5, the invention provides methods and systems for welding dissimilar metals and may be employed in any situation in which different first and second metal workpieces are to be welded. One situation in which it is desirable to join workpieces of different metal materials is exemplified in FIG. 4, wherein a pipeline 20 is fabricated for transporting fluids, which may be gaseous or liquid. The exemplary pipeline 20 is constructed by welding together various cylindrical metal pipe sections 6, 8, 10, 12, 14, 16, . . . , beginning with a first section 6 at a first pipeline end 2 at which transported fluid is to be introduced into the pipeline 20. In this example, moreover, the fluid is heated to a temperature above ambient at the input end 2, for example, where a pump or other pressurizing mechanism (not shown) provides the fluid to the pipeline 20 at the first end 2. Absent further thermal excitation, the fluid travels along the pipeline 20 and gradually looses heat to a point where the transported fluid is at ambient temperature. FIG. 3 illustrates a graph 30 showing corrosivity of low carbon steel pipe sections as a function of temperature for a given transported fluid. As shown in the graph 30, the pipe section corrosion increases with temperature, with a maximum acceptable amount of corrosion 32 being reached at a temperature T2 which is above the ambient temperature T_{AMBIENT}. Beyond this temperature T2, pipe corrosion becomes unacceptable.

FIG. 5 provides another graph 40 illustrating fluid temperature in the pipeline 20 of FIG. 4 as a function of distance from the first end 2 thereof for the fluid of interest. As can be seen in this example, the transported fluid begins at an initially high temperature 42 at the first end 2 of the pipeline 20, and the fluid temperature decreases with increased distance to the temperature T2 at a certain distance 44 (distance 44 is also indicated in FIG. 4). At longer distances from the pipeline entrance 2, the fluid temperature drops below T2 and eventually reaches the ambient temperature T_{AMBIENT}. Consequently, it is noted in FIG. 4 that low carbon steel pipe sections 12, 14, and 16 can be used beyond the distance 44 with acceptable corrosion to minimize pipeline construction costs, while more corrosion resistant pipe sections 6, 8, and 10 (e.g., stainless steel) must be used closer to the entrance end 2. Thus, the pipeline 20 of FIG. 4 is one instance in which it is desirable to use the higher cost stainless materials only to the extent necessary, and to utilize lower cost low-carbon steel wherever possible, whereby it is necessary to weld the last stainless section 10 to the first low-carbon section 12.

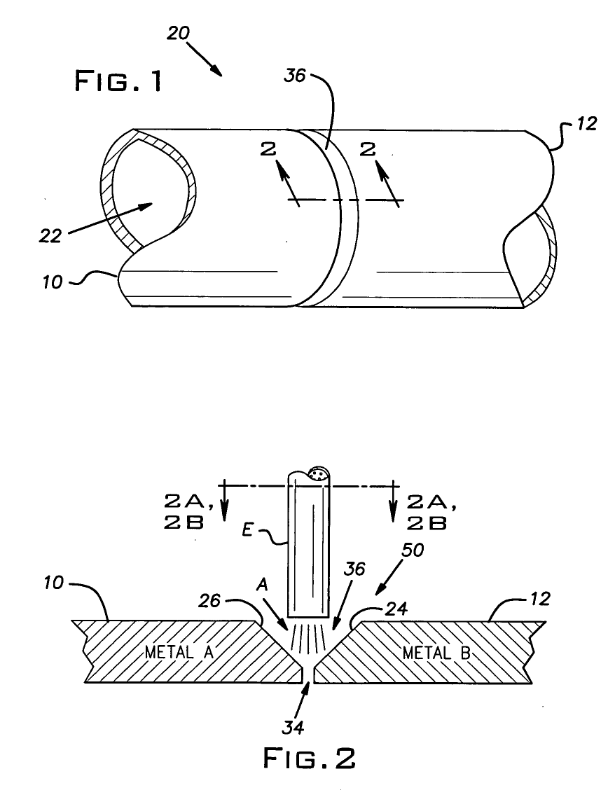

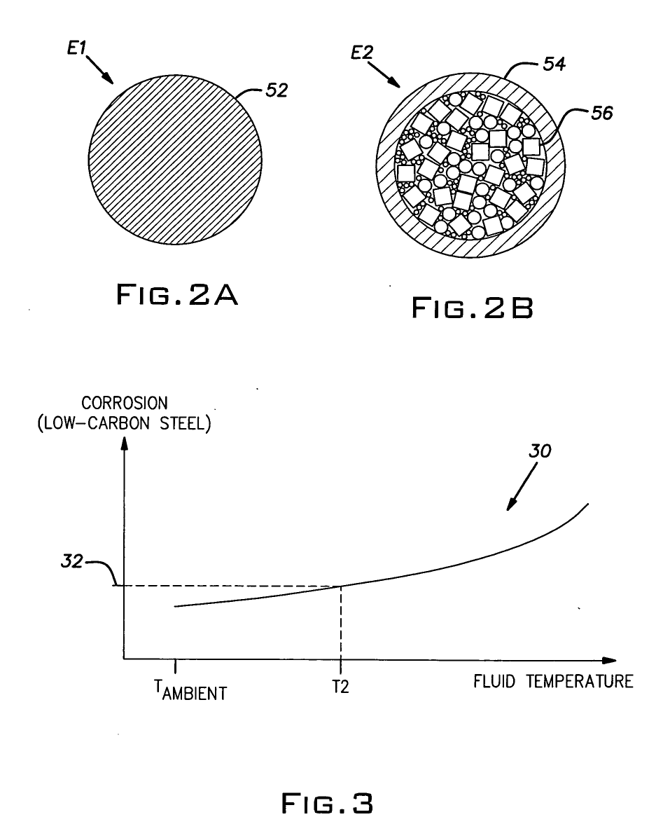

Referring now to FIGS. 1 and 2, the first and second dissimilar pipe section workpieces 10 and 12 are illustrated during a welding process 50 according to the invention to join longitudinal ends thereof to form the pipeline 20 for transporting liquids and/or gases in an interior 22 thereof. The exemplary first workpiece 10 is made of a first metal material (indicated as METAL A in FIG. 2), such as duplex stainless steel having a chromium (Cr) alloy content of about 20 to 27 percent, a nickel (Ni) content of about 4 to 9 percent, a manganese (Mn) content of about 1.5 to 2.5 percent, and a molybdenum (Mo) content of about 2 to 4 percent in one example. Stainless steels as discussed herein include iron base materials that are resistant to rusting and corrosion in many environments by virtue of non-zero chromium (Cr) content, typically about 12 percent by volume or more, wherein the chromium tends to oxidize to form a layer of chromium oxide on the material surface that protects against rust and corrosion. In joining stainless steel sections 6, 8, and 10 to one another, the welding electrode material is typically selected to closely match the metallurgical content of the workpieces 6, 8, and 10, for example, with respect to Cr and Ni content. As discussed further below, stainless steel pipe sections may be advantageously employed in portions of the finished pipeline 20 that are subject to high temperature transported fluids in situations where substitution of other more cost effective materials (e.g., low carbon steel) may result in unacceptable levels of pipe corrosion.

The exemplary second pipe section workpiece 12 is made from more cost-effective low carbon steel (METAL 2 in FIG. 2), wherein the workpiece 12 has essentially no appreciable Cr or Ni content. Normally, such low-carbon steel workpieces 12, 14, 16, may be welded to one another using many different welding electrodes, where the electrode selection can be made to maximize welding speed and thereby minimize cost. Accordingly, such low carbon steel workpieces are typically welded to one another using electrodes selected according to joint type, where the so-called fast-fill types are constructed to melt rapidly, fast-freeze electrodes solidify quickly, and fast-follow types facilitate fast electrode travel with minimum skips, and various combined types (e.g., fill-freeze electrodes) are also available. In general, the various aspects of the invention are applicable to any welding of two workpieces constructed of any type of metal materials where the first and second metals are different. Some possible examples of such metal materials include steel, nickel, copper, stainless steel, alloys and combinations thereof, etc.

Referring now to FIGS. 2, 2A, and 2B, in accordance with the present invention, the workpieces 10 and 12 are welded to one another as shown in FIG. 2, using an arc welding process 50 that employs a welding electrode E, which can be solid or cored, wherein the process 50 may use external shielding gas (not shown) or the process 50 can be a self-shielding welding operation in which the heat of a welding arc A causes decomposition and some vaporization of a flux core material 56 (FIG. 2B) to protect the molten metal deposited onto the workpieces 10, 12. FIGS. 2A and 2B illustrate two possible electrodes E1 and E2, respectively, suitable for use in a welding method or system of the present invention, wherein FIG. 2A shows a solid welding electrode E1 comprising a solid electrode material 52 and FIG. 2B illustrates an exemplary cored type electrode E2 having a metallic outer sheath 54 surrounding an inner core 56, where the core 56 includes granular flux material for providing a shielding gas and protective liquid (e.g., slag) to protect a molten weld pool during the process 50, as well as alloying materials to set the material composition of the weld joint material. As discussed below, the material 52 of the solid electrode E1 and the alloy material 56 in the cored electrode E2 may advantageously be tailored according to the material properties of the first and second metals of the workpieces 10 and 12 to facilitate the physical properties and corrosion resistance of the weld joint. Prior to welding, the longitudinal ends or edges to be joined are machined to create outwardly extending beveled surfaces 24 and 26 leaving small generally horizontal flats near the inner pipe sections walls, as shown in FIG. 2. The workpieces 10 and 12 are then axially aligned and brought into close proximity (e.g., closely spaced relationship) wherein the flats at the pipe section ends may but need not touch. In the illustrated case, a narrow root gap 34 remains between the flats into which a root bead will be deposited, with the beveled surfaces 24 and 26 defining an outwardly facing weld groove 36 to be filled by subsequent welding passes following the root pass.

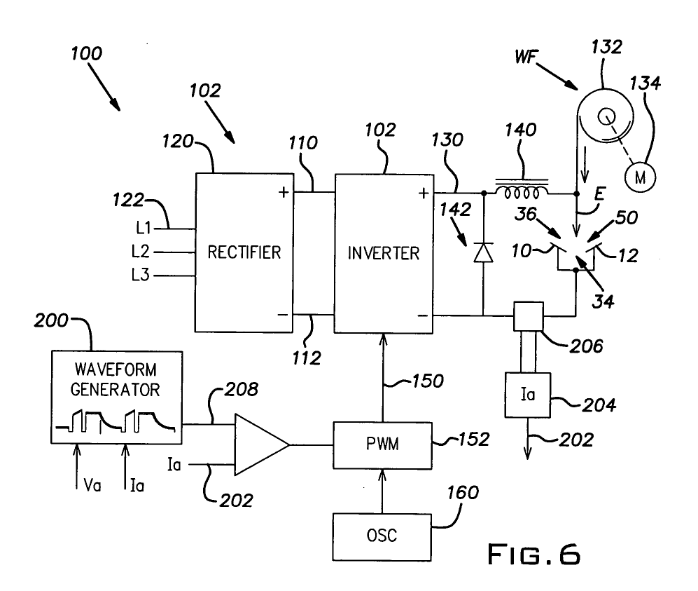

Referring also to FIGS. 6-8F, in order to ensure acceptable resistance to corrosion in the finished pipeline 20, it is desirable to weld the dissimilar metal workpieces 10 and 12 using waveforms providing a series of modified short-circuit type welding cycles to minimize adverse effects of excessive heat input when joining the stainless steel section 10 to the low carbon second pipe section 12. The application of welding current and voltage waveforms of the invention may be carried out using any suitable welding equipment, such as switching power sources employing waveform control technology, exemplified by welders sold by the Lincoln Electric Company of Cleveland, Ohio bearing the trademark STT, to minimize loss of corrosion resistance and toughness, and to avoid post-weld cracking, particularly at the weld joint and in surrounding heat-affected zones of the pipeline sections 10 and 12. This technology advantageously facilitates control of thermal input to the workpieces 10, 12 with reduced spatter and smoke generation, in which the current provided to the welding electrode E is controlled precisely and rapidly during the entire welding cycle with a waveform generator and a switching type power source operating to adjust current automatically according to the instantaneous heat requirements and/or limitations of the process 50.

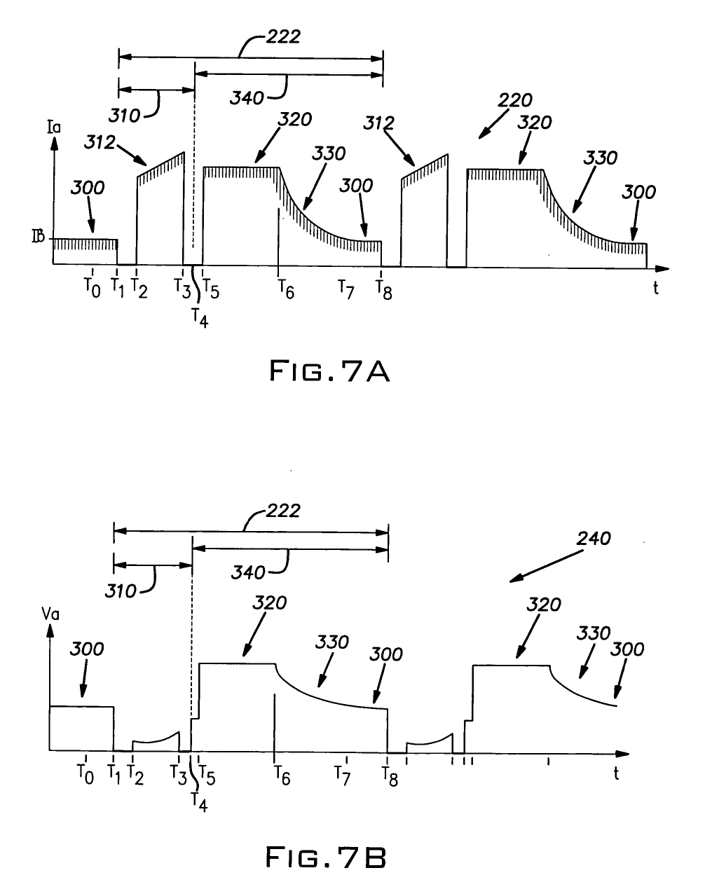

FIG. 6 illustrates an exemplary modified short-circuit welding system or welder 100 for joining dissimilar metals, including a switching power source 102 and a waveform generator or wave shape control circuit 200 in accordance with the invention. FIG. 7A shows a welding current waveform 220 representing the current Ia provided to the welding electrode E. FIG. 7B illustrates a corresponding voltage waveform 240, wherein the waveforms 220 and 240 are provided by the welder 100 during a series of welding cycles 222 according to a waveform signal 208 from the waveform generator 200. According to an aspect of the invention, the waveforms provide for a series of welding cycles 222 that individually include an arc condition 340 in which electrode E is spaced from workpieces 10 and 12 and an arc A is formed therebetween (FIG. 2) with molten metal being formed on the end of electrode E. Each welding cycle also includes a short-circuit condition 310 during which the molten metal contacts the workpieces (e.g., including touching a weld puddle or pool in the gap 34 or groove 36 and/or contacting one or both of the workpieces 10, 12) and then transfers from electrode E to workpieces 10, 12, along with a metal breaking fuse condition during which the molten metal separates from electrode E. In addition, waveform generator 200 controls current Ia according to a detected start of short-circuit condition 310 and according to a detected or anticipated start of the metal breaking fuse condition, wherein a controlled boost pulse 320 is provided to electrode E during arc condition 340 to establish an arc length and to form the molten metal on electrode E and a controlled background current I_{B} is provided to electrode E following boost pulse 320 to control heating of arc A until a short-circuit condition of a subsequent welding cycle 222. In this manner, the welding methods and systems of the invention provide for modified short-circuit welding of dissimilar metals with controlled heat input so as to facilitate structural integrity and corrosion resistance in the finished weld joint and the surrounding heat affected areas of workpieces 10 and 12.

Welder 100 of FIG. 6 employs a switching power source, such as a down chopper or a high speed switching inverter 102 with a DC input link having a positive terminal 110 and a negative terminal 112 for receiving DC power from a three phase rectifier 120 with a three phase input power supply 122 or from a generator (not shown). Inverter 102 provides an output 130 in the form of a current Ia supplied to electrode E and a voltage Va between electrode E and workpieces 10, 12 that is controlled according to waveform generator 200. The provision of current Ia causes melting and deposition of electrode material to weld workpieces 10 and 12, wherein electrode E is supplied to welding process 50 by a wire feeder WF including a supply reel 132 with a motor 134 for directing electrode E toward the beveled workpiece edges including the root gap 34 and the beveled edges 24 and 26 to be joined (e.g., pipe section ends in FIG. 2 above). An inductor 140 is provided in the output path along with a freewheeling diode 142 for stabilizing the output welding current Ia so as to follow or track a current waveform provided by waveform generator 200. The current and voltage waveforms of FIGS. 7A and 7B may be provided in a welding process 50 using any suitable hardware and/or software/firmware within the scope of the invention, wherein the illustrated system 100 provides a pulse width modulated control signal voltage 150 to inverter 102 having a voltage determined by the output of a pulse width modulator 152 preferably operated at a rate of about 18 kHz or more by an oscillator 160. Inverter 102 outputs a signal 150 comprising a rapid succession of current pulses, wherein pulse width modulator 152 determines the width of each current pulse provided from inverter 102 to output 130, with the welding current and voltage waveforms 220 and 240 being constructed as a composite of the high frequency pulses in a manner as taught in Stava U.S. Pat. No. 5,742,029 incorporated herein by reference. In the illustrated circuit of FIG. 6, wave shape control circuit 200 provides an output voltage signal 208 that is compared to a current feedback signal 202 from a current sensor 204 representing the welding current Ia passing through a current shunt 206 (e.g., representing the arc current through electrode E). The system 100 further includes voltage sensing means (not shown) to provide feedback to the waveform generator 200 regarding the welding voltage Va, wherein the waveform generator 200 includes circuitry, software, and/or hardware to detect the onset of the short-circuit condition as the molten metal at the end of electrode E initially contacts the workpieces 10, 12, and to detect or anticipate the metal-breaking fuse condition when the molten metal separates from electrode E in each welding cycle 222.

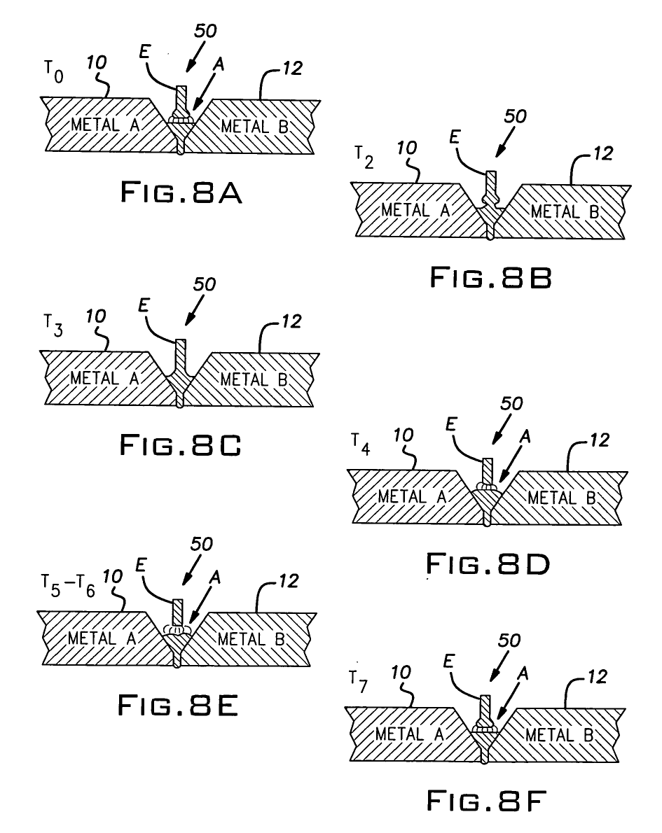

Referring now to FIGS. 7A, 7B, and 8A-8F, the welding waveforms 220 and 240 provide a welding cycle 222 repeated successively as electrode E advances toward workpieces 10, 12 and material therefrom is melted and deposited between pipe sections 10, 12 to create an initial root bead. For purposes of discussion, the exemplary welding cycles 222 are illustrated as beginning with the onset of the short-circuit condition at a time T₁ and ending at a time T₈ with the start of the short-circuit condition of a subsequent cycle. However, the cycles 222 could alternatively be described using any point in the illustrated waveforms 220, 240 as an arbitrary start point. Referring also to FIG. 8A, time T₀ in waveforms 220,240 illustrates background heating of the arc condition 310, during which a background current I_{B} is provided to electrode E. The welding current Ia is controlled according to the particular condition of the welding cycle 222, wherein waveform generator 200 determines from the current and voltage feedback signals Ia and/or Va whether an arc A exists (FIGS. 8A and 8D-8F) or whether the molten metal at the end of electrode E is short-circuited to workpieces 10, 12 (FIGS. 8B and 8C). During the period from tome T₀ to time T₁, (FIG. 8A), a background current level I_{B} is provided to electrode E, such as about 50 to 100 A in one example. This portion of the welding cycle 222 may be indicated as a background portion 300. Eventually, enough molten material forms and contacts the weld pool of workpieces 10, 12. When this short-circuit condition begins at T₁, if current Ia were high (e.g., 150 to 200 A), the ball would immediately be repelled, usually breaking apart and causing undesirable spatter due to high current flowing through a small initial contact area, causing an undesirable condition known as a “fuse explosion.” However, the exemplary welder 100 combats this adverse effect by employing a background current value I_{B}.

The cycle 222 begins with the onset or start of a short-circuit condition 310 in which molten metal on the lower end of electrode E contacts the workpieces 10, 12 at time T₁. At T₁, electrode E initially shorts (e.g., at the background current level), and waveform generator 200 detects the start of short-circuit condition 310, for example, by detecting the rapid decrease in the voltage Va (e.g., using a dv/dt circuit or other software/hardware/firmware techniques for detecting the start of the short-circuit condition 310 at T₁). The period from time T₁, to time T₂ is sometimes referred to as a ball time, during which the background current is further reduced (e.g., to about 10 A or less for approximately 0.75 milliseconds in one example). During this time, a solid mechanical short or bridge is formed between electrode E and the weld pool of workpieces 10, 12. A high current pinch mode is thereafter created for the period from time T₂ to T₃, wherein the waveform generator 200 causes the current Ia to increase to facilitate transfer of the molten ball material from the end of electrode E to the workpieces 10, 12 or a molten weld pool thereof, as shown in FIG. 8B. In the illustrated implementation, the time T2 is about 0.75 millisecond after T1, with a pinch pulse (e.g., current pulse) 312 being applied to the shorted electrode E in the form of an increasing, dual-slope ramp to accelerate molten metal transfer from electrode E to the weld pool by applying electronic pinch forces (FIG. 8C), which provides an axial, inwardly-directed pressure on the shorted bridge. As shown in FIG. 7B, voltage Va is non-zero during this period from T₂ to T₃, due to the relatively high electrical resistivity of the molten iron (e.g., at its melting point). Moreover, voltage Va is increasing during the pinch period T₂-T₃, wherein waveform generator 200 monitors the rate of change (e.g., dVa/dt) in the pinch mode period. Once the rate increases to a predetermined level at time T₃, waveform generator 200 reduces the current level Ia (e.g., to about 50 A or less in one example) before the shorted electrode E separates from workpieces 10 and 12.

Thereafter, waveform generator 200 monitors welding process 50 to predict or anticipate an imminent fuse condition. Other implementations are possible, wherein the actual fuse condition is detected rather than anticipated. In the illustrated implementation, voltage Va is observed and the rate of change thereof (e.g., dVa/dt) is compared with a predetermined value from time T₃ to T₄ using any suitable premonition circuitry, software, etc., where voltage Va rises quickly at T₄, indicating that a metal-breaking fuse condition is about to occur. During the period from T₃ to T₄, the shorted bridge necks down, wherein the cross-sectional area of the lower end of electrode E is decreasing, whereby the electrical resistance increases. This rate of change in resistance (e.g., dR/dt) is essentially measured by the voltage rate of change since the current Ia is held at a relatively constant low level. A circuit or other monitoring means produces a signal when the rate of change of the shorted bridge voltage Va equals or exceeds a specific predetermined value, thereby indicating that the short is about to break or separate (imminent fuse condition), and this signal is used to reduce welding current Ia quickly, so that when the fuse separation actually occurs, it does so at a low current, typically 50 A, and produces minimal spatter. Accordingly at T₄, the fuse is detected or anticipated, as shown in FIG. 8D, where waveform generator 200 maintains the current Ia at a low level so as to minimize spatter in welding process 50 until time T₅.

After the fuse condition at T₄, an arc condition 340 begins and continues until the short-circuit condition of the subsequent cycle 222 at T₈. A plasma boost pulse 320 begins at T₅, with high arc current Ia being applied to quickly melt the electrode E back. This controlled boost pulse 320 reestablishes arc A, as shown in FIG. 8E, with a desired arc length. Electrode E is quickly saturated by this high current 320 and begins to melt. In addition, jet forces associated with this high current boost pulse 320 act upon the weld pool (operating as a cathode) to slightly depress the molten surface, thereby increasing the arc length and minimizing the possibility of electrode E shorting prematurely. The plasma-boost current pulse 320 is maintained for a predetermined period from T₅ to T₆ (e.g., about 1 to 2 milliseconds in one example), to avoid melting too much electrode material and thereby causing spatter. In one implementation, waveform generator 200 controls the energy delivered to electrode E during boost pulse 320 (e.g., controls the time T₅ to T₆) to maintain a generally constant melt-off rate as the electrode extension (e.g., stick-out) changes. The plasma boost portion 320 of the cycle 222 plays an important role in producing a weld with good fusion and without incomplete fusion. The high current level momentarily broadens arc A and produces high cathode spot heating of the plate, thereby ensuring or facilitating proper wetting of the molten metal and complete fusion in the finished root bead.

A plasma portion then ensues with a current level tailout 330 from time T6 to T7, and molten metal begins to form again at the end of electrode E (FIG. 8F). During this portion of the exemplary cycle 222, current Ia is reduced logarithmically to the background level I_{B} so as to mechanically dampen the weld pool agitation which would otherwise occur if plasma boost pulse 320 were suddenly removed. Weld current Ia is thus slowly decrease to the background level I_{B} following boost pulse 320 to control heating of arc A until a short-circuit condition (e.g., at T₈,) of a subsequent welding cycle 222. The magnitude of the background current I_{B} serves to ensure that adequate power is provided to arc A to overcome radiation losses in order to maintain the fluidity of the molten drop on the end of electrode E. In one implementation, background level I_{B} can be set according to the shielding gas, electrode type, diameter, and wire feed speed, where background current I_{B} operates to supply enough heat to maintain the fluidity of the electrode ball while minimizing or controlling plate heating. In this regard, failure to provide this minimum current level I_{B} could cause the upper portion of the molten ball to freeze. In this situation, as more of the ball solidifies, arc instability and finally stubbing may occur. Background current I_{B} also controls the heat applied by welding process 50 to the weld pool and to heat affected zones of workpieces 10 and 12. In addition, reduction of current Ia to background level I_{B} also mitigates spatter in process 50, and tension forces at the surface of the molten metal cause formation of a molten drop on the end of electrode E in a generally spherical shape.

The invention thus provides welding techniques and apparatus for joining two metals having different compositions, which can be employed in any application in which dissimilar metals are to be welded. In open root pass pipe welding applications as illustrated herein, the exemplary welding techniques and systems of the invention advantageously provide waveform control for the process current and voltage, thereby facilitating control of weld penetration, fusion, and back bead, along with prevention of excessive spatter and fume generation. As opposed to conventional constant current (CC) or constant voltage (CV) welding control, the exemplary welder 100 provides high-frequency control of voltage and current waveforms in which the power to the arc process 50 is based on the instantaneous arc requirements, rather than on an average DC voltage. The process 50, moreover, can employ external shielding gas, where the welding system 100 may include appropriate gas storage and delivery apparatus (not shown).

Another aspect of the invention provides for tailoring the electrode material according to the first and second metals of the workpieces 10 and 12, respectively. In the illustrated implementation, the exemplary duplex stainless steel workpiece 10 may generally include approximately equal ferrite and austenite metallographic structures by volume, although the ferrite percentage can range from about 20 to 80 percent, with some examples including so-called lean duplex stainless steel having essentially zero Mo content (e.g., 2304 (S32304), 2205 (S32205), 25 Cr duplex (e.g., S32550 and S31260), 25-26 Cr duplex stainless steel with higher Mo content (e.g., 2507 (S32750), sometimes referred to as Superduplex), wherein duplex stainless steels generally provide superior mechanical properties compared with more austenitic materials, along with resistance to chloride pitting corrosion and stress corrosion. Duplex materials generally include a substantial Cr proportion with additional balanced quantities of Ni, Mo, and copper (Cu) in an iron base, wherein the carbon, sulphur, and phosphorus contents are typically relatively low. These materials are desirable due to improved corrosion resistance and good mechanical strength compared with highly austenitic stainless steels, as well as thermal conductivity and thermal expansion properties between those of carbon and austenitic stainless steels. With respect to pipeline applications in general, duplex stainless steel materials are less susceptible to internal stresses than austenitic stainless steels, because of their higher thermal conductivity and lower coefficient of thermal expansion.

In welding duplex stainless steel workpieces together, process parameters and electrode materials are generally selected to avoid degradation of these properties and to avoid excessive time at elevated temperatures. Bare stainless steel filler metals for welding duplex stainless workpieces together are set forth in specification AWS A5.9, and the filler metals are generally chosen either with matching compositions or sometimes with slight excess of Ni to promote more austenitic structure. For example, to weld duplex stainless steels to other duplex grades, duplex stainless filler metal may be used with higher Ni content than base material, such as electrode types ER2209 and 25Cr-10Ni-4Mo-N. In the past, therefore, welding electrodes have been selected for welding duplex stainless steel workpieces to one another based on an attempt to closely match the metallographic structure of the electrodes to that of the workpieces being joined. Furthermore, as discussed above, electrode selection for welding low-carbon steel workpieces 12, 14, 16 together has been previously based largely on joint type (e.g., fast-fill, fast-freeze, fast-follow, fill-freeze types, etc.). However, these selection criteria may not prove optimal in the context of welding dissimilar metals as in the illustrated pipeline 20.

In certain implementations of the invention, therefore, an alloying material of electrode E, particularly alloying elements in core 56 of cored electrode E2 (FIG. 2B) can be tailored or selected according to properties of both said first and second metals. Thus, instead of matching the electrode material properties (e.g., alloy content) to those of one or the other of the workpieces 10, 12, electrode E is selected according to the properties of both dissimilar workpieces 10 and 12. In the above-described example, this may be accomplished by providing electrode E having a non-zero alloying material content percentage (e.g., the content of the material 52 of a solid electrode El (FIG. 2A) or an alloying material in the core 56 of a flux-cored electrode E2 (FIG. 2B)) that is between the corresponding content of the first and second workpiece metals. For instance, the first pipe section 10 (duplex stainless steel) has a Cr content of about 20 to 27 percent and a nickel (Ni) content of about 4 to 9 percent, where the second section 12 (e.g., low carbon steel) has essentially no chromium or nickel. In this case, electrode E may be provided having non-zero Cr content less than 20 percent (e.g., about one half the workpiece content or more, such as bout 10 to 15 percent), and/or a non-zero Ni content less than 4 percent (e.g., about 2 to 3 percent). This tailoring of the material properties of electrode E may therefore accommodate the joinder of the dissimilar metals by providing high quality weld joint therebetween which mitigates corrosion in the finished pipeline. In this regard, electrode E preferably includes a content of at least one alloying material that is between the corresponding content amounts of both the dissimilar metals, more preferably skewed toward the content of the workpiece metal having the larger corresponding alloy material content. In this manner, the properties of the weld joint will be somewhat more closely matched to those of the more corrosion resistant material, while providing a metallographic transition at the weldjoint between the different workpieces 10 and 12 in the construction of pipeline 20.

Although the invention has been illustrated and described hereinabove with respect to one or more exemplary implementations, equivalent alterations and modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary implementations of the invention. In addition, although a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in the detailed description and/or in the claims, such terms are intended to be inclusive in a manner similar to the term “comprising.”

1. A welding method, comprising:
(a) locating edges of first and second workpieces proximate one another, said first and second workpieces being of different first and second metals, respectively;
(b) directing a welding electrode toward said workpiece edges; and
(c) providing current to said electrode to deposit molten metal from said electrode to said workpieces to join said workpieces in a sequence of welding cycles, each of said welding cycles including: an arc condition during which said electrode is spaced from said workpieces, an arc is formed between said electrode and said workpieces, and molten metal is formed on an end of said electrode, a short-circuit condition during which said molten metal on said end of said electrode contacts said workpiece and then transfers from said electrode to said workpiece, and a metal breaking fuse condition during which said molten metal separates from said end of said electrode; and
(d) controlling said current supplied to said electrode according to a detected start of said short-circuit condition and according to a detected or anticipated start of said metal breaking fuse condition;
wherein providing current to said electrode comprises providing a controlled boost pulse to said electrode during said arc condition to establish an arc length and to form said molten metal on said end of said electrode, and providing a controlled background current to said electrode following said boost pulse to control heating of said arc until a short-circuit condition of a subsequent welding cycle.

2. A method as defined in claim 1, wherein said first and second metals are selected from the group consisting of steel, nickel, copper, stainless steel, steel alloys, nickel alloys, copper alloys, stainless steel alloys, and combinations thereof.

3. A method as defined in claim 2, wherein said first and second workpieces are generally cylindrical pipe sections.

4. A method as defined in claim 1, wherein said first and second workpieces are generally cylindrical pipe sections.

5. A method as defined in claim 4, wherein locating said edges of said first and second workpieces proximate one another comprises providing a gap between said edges.

6. A method as defined in claim 3, wherein locating said edges of said first and second workpieces proximate one another comprises providing a gap between said edges.

7. A method as defined in claim 2, wherein locating said edges of said first and second workpieces proximate one another comprises providing a gap between said edges.

8. A method as defined in claim 1, wherein locating said edges of said first and second workpieces proximate one another comprises providing a gap between said edges.

9. A method as defined in claim 8, wherein said welding electrode is a cored electrode.

10. A method as defined in claim 4, wherein said welding electrode is a cored electrode.

11. A method as defined in claim 2, wherein said welding electrode is a cored electrode.

12. A method as defined in claim 1, wherein said welding electrode is a cored electrode.

13. A method as defined in claim 1, further comprising tailoring an alloying material of said electrode according to properties of both said first and second metals.

14. A method as defined in claim 8, wherein said molten metal is deposited to said workpieces to create a root bead to join said workpiece edges.

15. A welding system for welding workpieces of dissimilar first and second metals with workpiece edges located proximate one another, said system comprising: a supply of welding electrode with an alloying material to join said first and second metals at said edges, said alloying material being tailored according to properties of both said first and second metals; a wire feeder adapted to direct said electrode toward said workpiece edges; a switching power source coupled with said electrode and providing current to said electrode in the form of a plurality of small width current pulses constituting a series of welding cycles to deposit molten metal from said electrode to said workpieces, each of said welding cycles including: an arc condition during which said electrode is spaced from said workpieces, an arc is formed between said electrode and said workpieces, and molten metal is formed on an end of said electrode, a short-circuit condition during which said molten metal on said end of said electrode contacts said workpiece and then transfers from said electrode to said workpiece, and a metal breaking fuse condition during which said molten metal separates from said end of said electrode; and a waveform generator coupled with said power source and controlling said current supplied to said electrode in each said welding cycle according to a detected start of said short-circuit condition and according to a detected or anticipated start of said metal breaking fuse condition; wherein said waveform generator causes said switching power source to provide a controlled boost pulse to said electrode during said arc condition to establish an arc length and to form said molten metal on said end of said electrode, and to provide a controlled background current to said electrode following said boost pulse to control heating of said arc until a short-circuit condition of a subsequent welding cycle.

16. In a pipe welding system for welding longitudinal ends of pipe sections together, a method of joining ends of two pipes formed of dissimilar first and second metals, said method comprising:
(a) providing first and second pipes formed of different first and second metals, respectively;
(b) locating first and second pipes in axial alignment with ends of said first and second pipes in spaced relationship to provide a gap therebetween;
(c) providing a welding electrode having alloying material tailored according to properties of both said first and second metals;
(d) directing said electrode toward said pipe ends; and
(e) energizing said electrode to create a sequence of welding cycles, said welding cycles individually comprising: an arc condition during which an arc is formed between said electrode and said pipes and molten metal is formed on an end of said electrode, a short-circuit condition during which said molten metal on said end of said electrode contacts said pipes and then transfers from said electrode to said pipes, and a metal breaking fuse condition during which said molten metal separates from said end of said electrode, wherein energy provided to said electrode is controlled according to a detected start of said short-circuit condition and according to a detected or anticipated start of said metal breaking fuse condition.

17. A method as defined in claim 16, wherein said first and second metals are selected from the group consisting of steel, nickel, copper, stainless steel, steel alloys, nickel alloys, copper alloys, stainless steel alloys, and combinations thereof.

18. A method as defined in claim 17, wherein said molten metal is deposited to create a root bead joining said pipe ends.

19. A method as defined in claim 16, wherein said molten metal is deposited to create a root bead joining said pipe ends.

20. A method as defined in claim 16, wherein said welding electrode further includes flux material for providing a shielding gas during welding.
